(19) United States
(12) Patent Application Publication
(10) Pub. No.: US 2013/0159048 A1
(43) Pub. Date: Jun. 20, 2013

(54) METHOD AND SYSTEM FOR ANALYZING AFFILIATION NETWORK BASED ON WORKFLOW

(71) Applicant: KYONGGI UNIVERSITY INDUSTRY ACADEMY COOPERATION GROUP, Suwon-si (KR)

(72) Inventors: Kwang-hoon Kim, Yongin-si (KR); Hyun Ahn, Anyang-si (KR)

(73) Assignee: KYONGGI UNIVERSITY INDUSTRY ACADEMY COOPERATION GROUP, Suwon-si (KR)

(21) Appl. No.: 13/720,744

(22) Filed: Dec. 19, 2012

(30) Foreign Application Priority Data
Dec. 20, 2011 (KR) 10-2011-0138642

(51) Int. Cl. G06Q 10/06

(52) U.S. Cl. CPC G06Q 10/0633
USPC 705/7.27

(57) ABSTRACT

The present invention discloses a method and system for analyzing an affiliation network based on workflow. The system for analyzing an affiliation network based on workflow in accordance with an embodiment of the present invention includes: a workflow management unit configured to generate and manage a workflow network constituted with a plurality of activities; an affiliation network conversion unit configured to convert the workflow network to an affiliation network indicating a relation between an actor and the activity; an affiliation matrix computation unit configured to generate an affiliation matrix based on the affiliation network; and an analysis unit configured to analyze the affiliation network based on the affiliation matrix.

### CROSS-REFERENCE TO RELATED APPLICATIONS

This application claims the benefit of Korean Patent Application No. 10-2011-0138642, filed with the Korean Intellectual Property Office on Dec. 20, 2011, the disclosure of which is incorporated herein by reference in its entirety.

### BACKGROUND

1. Technical Field

The present invention relates to a method and system for analyzing an affiliation network based on a workflow model in an organization.

2. Background Art

A workflow is a business process automation system that integrates management and support of the flow of people and information resources related to tasks defined in a corporate business.

An enterprise can design and manage a business process by introducing a workflow model in order to efficiently manage and administer organizational information, management information, partner information and the like in the organization.

By introducing a workflow model, the enterprise can also automate the processes, improve the business productivity, increase the business process efficiency and save the costs.

The workflow model expresses the state of the organization in task, actor, role, activity and repository. This workflow model is defined in a builder time and carries out functions such as generating, searching and controlling a process based on the information predefined during a runtime.

FIG. 1 illustrates a workflow meta model that shows a set of object types essentially required for defining a workflow model and defines the relations among the object types.

The object types constituting a workflow model include workflow procedure, activity, role, actor, relevant data, transition and calling application.

The workflow procedure is a process that is defined with a set of unit tasks, defined as activity, and an execution order among the unit tasks. A workflow management system is structured, controlled and executed by the defined workflow procedure. Moreover, a control flow included in the workflow procedure is expressed as a combination of basic control flow types for activities, namely, sequential, disjunctive, conjunctive and repetitive control flow types.

The activity is a basic unit task that constitutes the workflow procedure. The activity is sorted into work activity, block activity, subprocess activity, gateway activity and event activity. There is a temporal order of execution among these activities, and this temporal order is defined through the basic control flow types of the workflow procedure, ultimately defining the workflow procedure.

The role and the actor are key elements defining the organization information for the workflow model. The role is the concept of a logical organization or a physical department and is assigned to the activity, and the actor is a person who handles execution of the work activity that constitutes the workflow procedure and is assigned with a particular role.

The relevant data is input/output data of each activity required when a workflow procedure instance is executed. The relevant data is used as input/output data of activities that constitute the pertinent process and is used as variables for transitions that determine the control flow of the process.

The transition condition is an object that is defined for control of the order of executing the activities based on the control flow of the workflow procedure. Such a transition defines the order of executing the activities by using the relevant data as the variables.

Meanwhile, as the scale of enterprise is expanded, the amount of tasks to be processes and relevant record data are exponentially increased. Accordingly, there has been a demand for new technologies for improvement and re-discovery of the workflow and business process.

A technique of discovering workflow process-related knowledge from a workflow package, which is defined with a series of workflow models, is referred to as a workflow intelligence discovery technique, and a technique of discovering workflow-related knowledge from log information, which is the execution history of the workflow models, is referred to as a workflow intelligence re-discovery technique. Whether or not discovery and re-discovery algorithms, and a framework therefor, of workflow process-related knowledge based on a large amount of workflow and business process models and their execution records are obtained is an important element for evaluating the value of the workflow management system and business process management system.

Among these, by discovering an affiliation network based on the workflow model, it is possible to assess the affiliation relation among the actors and the activities assigned to the workflow model, and it is possible to assess the human resources assigned to a task carried out in the organization and their associated costs and affiliation level through an analysis thereof. Here, the affiliation network refers to a network model that indicates a mutual relation formed among the actors and the activities based on role responsibility and actor assignment information defined on the workflow model.

Therefore, it is required to introduce a method and system for analyzing an affiliation network that can readily discover the affiliation network from the workflow model that is currently managed or planned to be managed in the organization and analyze the affiliation relation among the actors and the activities through the discovered affiliation network.

Korean Patent Publication 2003-0032593 discloses an invention titled “SYSTEM AND METHOD FOR WORKFLOW MINING.” The invention of Korean Patent Publication 2003-0032593 relates to a workflow mining system which can evaluate, analyze and determine previous execution results of processes or activities by applying a data mining technique to workflow log data accumulated during the operation of a workflow system, and a method therefor.

### SUMMARY

Contrived to overcome the above-described conventional problems, the present invention provides a method and system that can extract a workflow model, which is information on the entire process within an organization in which a workflow management system is introduced, to show an affiliation relation among all human resources belonging to an organization and their associated processes and can analyze the human resources assigned to tasks carried out by the organization and their associated costs and affiliation level by analyzing the affiliation relation.

An aspect of the present invention features a system for analyzing an affiliation network based on workflow. The system for analyzing an affiliation network based on workflow in accordance with an embodiment of the present invention can include: a workflow management unit configured to generate and manage a workflow network constituted with a plurality of activities; an affiliation network conversion unit configured to convert the workflow network to an affiliation network indicating a relation between an actor and the activity; an affiliation matrix computation unit configured to generate an affiliation matrix based on the affiliation network; and an analysis unit configured to analyze the affiliation network based on the affiliation matrix.

Here, the affiliation network conversion unit can convert the workflow network to the affiliation network indicating a relation between the actor and the activity based on role information and actor information defined on the workflow network.

The workflow network can include at least one of activity information, repository information, role information and actor information.

The affiliation matrix computation unit can generate an involvement matrix and a participation matrix from the affiliation matrix.

The analysis unit can analyze the involvement matrix to determine whether the actor is involved in the activity and analyze the participation matrix to determine whether the actor is participated in the activity.

A row and a column of the involvement matrix can correspond to the actor, and a non-diagonal element of the involvement matrix can display the number of activities in which two actors paired from the row and the column, respectively, are jointly involved, and a diagonal element of the involvement matrix can display the number of activities in which each actor is involved.

A row and a column of the participation matrix can correspond to the activity, and a non-diagonal element of the participation matrix can display the number of actors jointly participating in execution of two activities paired from the row and the column, respectively, and a diagonal element of the participation matrix can display the number of actors assigned for execution of each activity.

The system for analyzing an affiliation network based on workflow can also include a storage unit configured to store at least one of the workflow network, the affiliation network and the affiliation matrix.

The storage unit can include: a workflow definition DB configured to store and manage the workflow network; an affiliation network DB configured to store and manage the affiliation network; and an affiliation matrix DB configured to store and manage the affiliation matrix.

Another aspect of the present invention features a method for analyzing an affiliation network based on workflow by using a system for analyzing an affiliation network based on workflow. The method for analyzing an affiliation network based on workflow in accordance with an embodiment of the present invention can include: converting a workflow network constituted with a plurality of activities to an affiliation network indicating a relation between an actor and the activity; generating an affiliation matrix based on the affiliation network; and analyzing the affiliation network based on the generated affiliation matrix.

Here, the workflow network can be converted to the affiliation network indicating a relation between the actor and the activity based on role information and actor information defined on the workflow network.

The workflow network can include at least one of activity information, repository information, role information and actor information.

The generating of an affiliation matrix can also include generating an involvement matrix and a participation matrix from the affiliation matrix.

The analyzing of the affiliation network can include: analyzing the involvement matrix to determine whether the actor is involved in the activity; and analyzing the participation matrix to determine whether the actor is participated in the activity.

A row and a column of the involvement matrix can correspond to the actor, and a non-diagonal element of the involvement matrix can display the number of activities in which two actors paired from the row and the column, respectively, are jointly involved, and a diagonal element of the involvement matrix can display the number of activities in which each actor is involved.

A row and a column of the participation matrix can correspond to the activity, and a non-diagonal element of the participation matrix can display the number of actors jointly participating in execution of two activities paired from the row and the column, respectively, and a diagonal element of the participation matrix can display the number of actors assigned for execution of each activity.

The method for analyzing an affiliation network based on workflow can also include displaying a result of analyzing the affiliation network.

Yet another aspect of the present invention features a computer-readable storage medium having stored a computer-executable program for execution of the method for analyzing an affiliation network.

### BRIEF DESCRIPTION OF THE DRAWINGS

FIG. 1 illustrates a workflow meta model that shows a set of object types essentially required for defining a conventional workflow model and defines the relations among the object types.

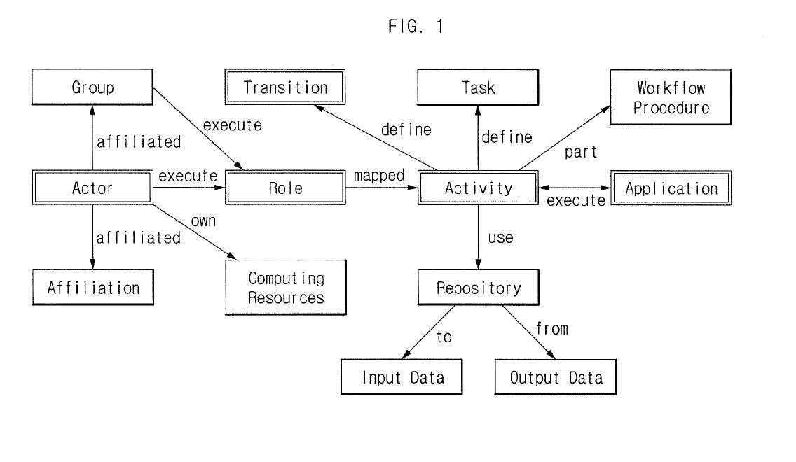

FIG. 2 is a diagram briefly illustrating a configuration of a system for analyzing an affiliation network based on workflow in accordance with an embodiment of the present invention.

FIG. 3 is a flow diagram of a method for analyzing an affiliation network based on workflow in accordance with an embodiment of the present invention.

FIG. 4 illustrates a workflow process model including activity-role-actor information.

FIG. 5 illustrates an affiliation network generated from the workflow process model shown in FIG. 4.

FIG. 6 illustrates an affiliation matrix generated based on the affiliation network shown in FIG. 5.

FIG. 7 illustrates how an involvement matrix and a participation matrix are obtained from the affiliation matrix shown in FIG. 6.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain technology is determined to evade the point of the present invention, the pertinent detailed description will be omitted. Terms such as “first” and “second” can be used in describing various elements, but the above elements shall not be restricted to the above terms. The above terms are used only to distinguish one element from the other.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

Hereinafter, certain embodiment of the present invention will be described in detail with reference to the accompanying drawings.

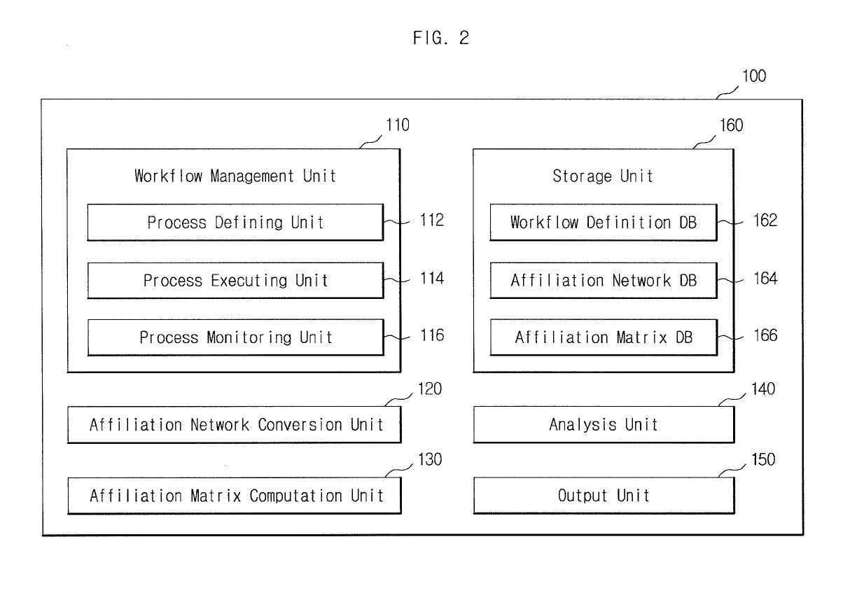

FIG. 2 is a diagram briefly illustrating a configuration of a system for analyzing an affiliation network based on workflow in accordance with an embodiment of the present invention.

Referring to FIG. 2, a system 100 for analyzing an affiliation network based on workflow in accordance with an embodiment of the present invention finds affiliation relations between all human resources belonging to an organization and their associated processes from a workflow process introduced to a company, analyzes human resources assigned to unit tasks carried out in the organization and their associated cost and task affiliation information based on the found affiliation relations, and provides the analyzed information to a user. For this, the system 100 for analyzing an affiliation network based on workflow converts a workflow network to an affiliation network based on workflow, obtains an affiliation matrix from the converted affiliation network, analyzes the affiliation network, and displays the analyzed affiliation network on a screen.

The system 100 for analyzing an affiliation network based on workflow includes a workflow management unit 110, an affiliation network conversion unit 120, an affiliation matrix computation unit 130 and an analysis unit 140. Moreover, the system 100 for analyzing an affiliation network based on workflow can also include an output unit 150 and a storage unit 160.

The workflow management unit 110 generates and manages the workflow network, which is constituted with a plurality of unit tasks. Specifically, the workflow management unit 110 defines and generates a workflow process for each task, and stores and manages the generated workflow process. For this, the workflow management unit 110 can include a process defining unit 112, process executing unit 114 and a process monitoring unit 116. The process defining unit 112 defines and generates the workflow process per task, and the process executing unit 114 executes the defined workflow process and processed associated input/output data. Moreover, the process monitoring unit 116 checks whether the executed process is normally operating and can send an alarm to an administrator or a re-execution request to the process executing unit 114 in the case of abnormal operation.

Moreover, the workflow management unit 110 can store the workflow process defined and generated by the process defining unit 112 in the storage unit 160 or store various log data generated while the process executing unit 114 executes the workflow process in the storage unit 160.

The affiliation network conversion unit 120 makes a conversion to an affiliation network that indicates a relation between the actor and the activity. Specifically, the affiliation network conversion unit 120 can use a workflow affiliation network knowledge discovery algorithm to automatically convert the affiliation network from the workflow process. Here, the affiliation network refers to a network model that indicates a mutual relation formed between the actors and the activities based on role assignment information and actor assignment information defined on a workflow model.

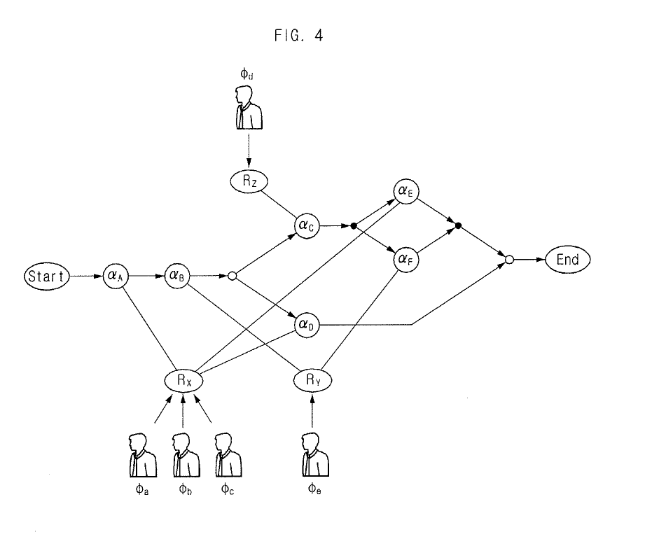

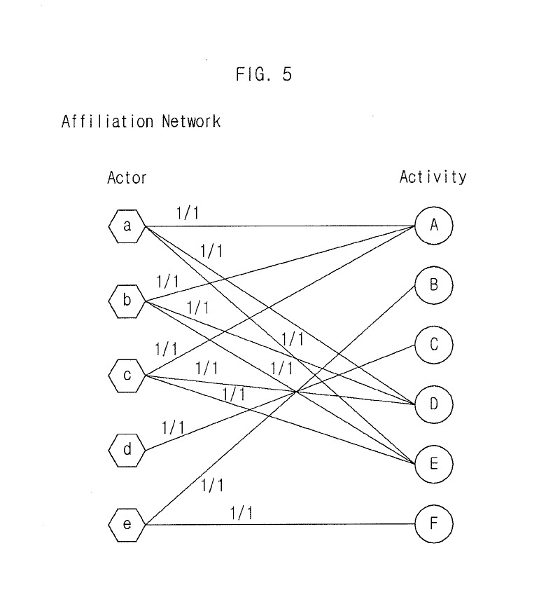

The affiliation network conversion unit 120 assesses the affiliation relation between the actors and the activities by taking activity, role and actor, which are objects of the workflow network, as constituting elements and generates the affiliation network. The workflow network can include activity information, repository information, role information and actor information as its objects. The affiliation network knowledge discovery algorithm will be described later in detail with reference to FIGS. 4 and 5. The affiliation matrix computation unit 130 generates an affiliation matrix by performing computation based on the affiliation network generated by the affiliation network conversion unit 120.

Specifically, the affiliation matrix computation unit 130 analyzes the generated affiliation network to convert the affiliation network to an affiliation matrix (bipartite matrix), wherein the affiliation matrix can be in the form of a two-dimensional matrix. The row and column of the affiliation matrix are expressed with all actors and activities related to the affiliation network.

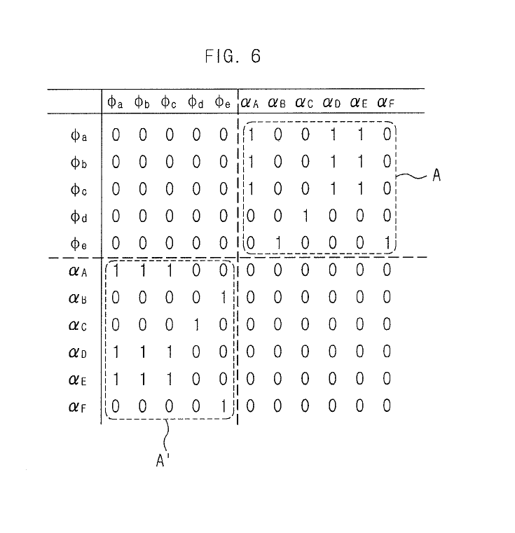

Moreover, the affiliation matrix computation unit 130 can generate an involvement matrix and a participation matrix from the affiliation matrix. The generated involvement matrix and participation matrix can be transferred to the analysis unit 140 for analysis. The detailed configuration of the affiliation matrix will be described in detail later with reference to FIG. 6.

The analysis unit 14Q uses the affiliation matrix generated by the affiliation matrix computation unit 130 to analyze the affiliation network. Here, the analysis unit 140 can utilize various analysis techniques, such as density analysis, centrality analysis, etc., in order to analyze the pertinent affiliation network.

Moreover, the analysis unit 140 can analyze the involvement matrix and the participation matrix generated by the affiliation matrix computation unit 130. Specifically, the analysis unit 140 can assess the involvement of the actors for each activity by analyzing the involvement matrix. Moreover, the analysis unit 140 can assess the participation of the actors in each activity by analyzing the participation matrix.

The output unit 150 displays the relation between the actors and the activities of the affiliation matrix analyzed through the analysis unit 140.

The storage unit 160 can include workflow definition DB 162, affiliation network DB 164 and affiliation matrix DB 166, and can store and manage data for the workflow network, the affiliation network and the affiliation matrix. The workflow process stored in the workflow definition DB 162 can include activity information, repository information, role information and actor information. Here, the activity information can include information on previous activity and following activity. Moreover, the workflow process can include mapping information, such as activity-role mapping information, activity-actor information and role-actor mapping information.

Hereinafter, a method for analyzing an affiliation network based on workflow will be described. In order to describe a method for analyzing an affiliation network, the present specification will take an example of an order processing model, which is one of the main workflow processes that are practically used. However, it shall be appreciated that the scope of rights of the present invention is not restricted to what is described herein but is applied to other workflow processes sharing the same concept.

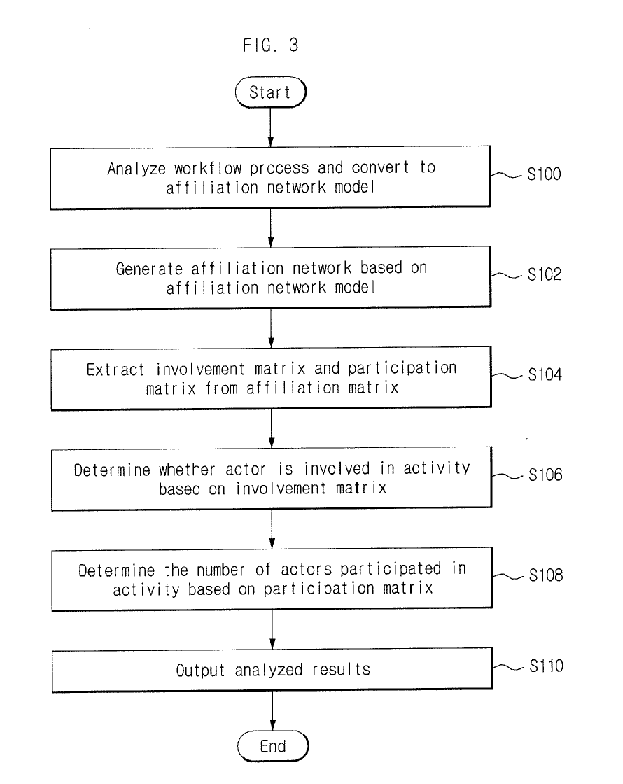

FIG. 3 is a flow diagram of a method for analyzing an affiliation network based on workflow in accordance with an embodiment of the present invention.

In S100, a workflow network is analyzed first and then is converted to an affiliation network. Conversion of the workflow network to the affiliation network can be automatically processed by the affiliation network conversion unit 120 using an affiliation network knowledge discovery algorithm.

FIG. 4 illustrates a workflow process model including activity-role-actor information, and FIG. 5 illustrates an affiliation network generated from the workflow process model shown in FIG. 4.

As shown in FIG. 4, the illustrated order processing workflow process model shows control flow and data flow among one or more activities α_{A}, α_{B}, α_{C}, . . . ,α_{F} For example, α_{B} is a following activity of α_{A} and a previous activity of α_{C} and α_{D.}

Moreover, the activities are allocated with respective roles R_{X}, R_{Y}, R_{Z}. For example, activities α_{A}, α_{D}, α_{E} are allocated with role R_{X}, and activity α_{C} is allocated with role R_{Z}.

Moreover, actors φₐ, φ_{b}, φ_{c}, φ_{d}, φₑ are assigned to respective roles and then allocated to respective activities through the roles. For example, role R_{X} is assigned with actors φₐ, φ_{b}, φ_{c}, and role R_{Y} is assigned with actor φₑ. Here, the relation between the activity and the role is expressed in a straight line, and the relation between the role and the actor is expressed in an arrow. It is of course possible to configure the present embodiment in such a way that the actor is directly allocated to the activity without the role therebetween, in which case the method can be even simpler by omitting the activity-role mapping step and the role-actor mapping step.

As such, control flow, role allocation and actor assignment relations among activities in the workflow network can be standardized as follows.

Firstly, the control flow among the activities can be expressed as δᵢ( ) and δₒ( ), wherein δᵢ(α) refers to a previous activity of activity α, δₒ(α) refers to a following activity of activity α. For example, δᵢ(α_{A}) is αₛₜₐᵣₜ, and δₒ(α_{A}) is α_{B}.

Moreover, an allocation model between the activity and the role can be expressed as εₚ( ) and εₐ( ), wherein εₚ(α) refers to a role that is responsible for execution of activity α and εₐ(R) refers to an activity of which no particular role is responsible for execution. For example, εₚ(α_{A}) is R_{X}, and εₐ(R_{Y}) is α_{B} and α_{F}.

Moreover, an assignment model between the role and the actor can be expressed as π_{C}( ) and ε_{P}( ) wherein π_{C}(R) refers to a set of actors assigned to a particular role and π_{P}(φ) refers to a set of roles to which a particular actor belongs. For example, π_{C}(R_{X}) is φₐ, φ_{b} and φ_{C}, and π_{P}(φ_{d}) is R_{Z}.

Therefore, the workflow network shown in FIG. 4 can be expressed by using the following functions.

Control flows δᵢ( ), δₒ( ) between activities are:

δᵢ(αₛₜₐᵣₜ)=null,δₒ(αₛₜₐᵣₜ)=α_{A},

δᵢ(α_{A})=αₛₜₐᵣₜ,δₒ(α_{A})=α_{B},

δᵢ(α_{B})=α_{A},δₒ(α_{B})=α_{C},α_{D},

δᵢ(α_{C})=α_{B},δₒ(α_{C})=α_{E},α_{F},

δᵢ(α_{D})=α_{B},δₒ(α_{D})=α_{end},

δᵢ(α_{E})=α_{C},δₒ(α_{E})=α_{end},

δᵢ(α_{F})=α_{C},δₒ(α_{F})=α_{end},

δᵢ(α_{end})=α_{D},{α_{E},α_{F}},δₒ(α_{end})=null

Allocation models ε_{P}( ), εₐ( ) between activity and role are:

εₚ(αₛₜₐᵣₜ)=null,εₚ(α_{A})=R_{X},εₚ(α_{B})=R_{Y},εₚ(α_{C})=R_{Z},

εₚ(α_{D})=R_{X},εₚ(α_{E})=R_{X},εₚ(α_{F})=R_{Y},εₚ(α_{end})=null,

εₐ(R_{X})=α_{A},α_{D},α_{E},εₐ(R_{Y})=α_{B},α_{F},εₐ(R_{Z})=α_{C}

Allocation models π_{C}( ), ε_{P}( ) between role and actor are:

π_{c}(R_{X})=φₐ,φ_{b},φ_{c},π_{c}(R_{Y})=φₑ,π_{c}(R_{Z})=φ_{d}

πₚ(φₐ)=R_{X},πₚ(φ_{b})=R_{X},πₚ(φ_{c})=R_{X}

πₚ(φ_{d})=R_{Z},πₚ(φₑ)=R_{Y}

The affiliation network conversion unit 120 can automatically generate the affiliation network shown in FIG. 5 by using workflow network data expressed in the above functions. The generated affiliation network can be configured through involvement functions σₚ, σᵥ and participation functions ψₐ, ψᵥ that are constituted with activities α_{A}, α_{B}, α_{C}, . . . ,α_{F} and actors φₐ, φ_{b}, φ_{c}, φ_{d}, φₑ among the elements shown in FIG. 4.

The involvement function indicates involvement knowledge, which is information on an activity in which a particular actor is involved, and σₚ(φ) refers to an activity in which a particular actor is involved, and σᵥ(φ, α) refers to a weight value for particular involvement link (φ, α). By using the above workflow network related functions, σₚ(φ) becomes εₐ(πₚ(φ), and σᵥ(φ, α) means the weight value of a connection link from φ to α.

Moreover, the participation function indicates participation knowledge, which is information on actors participating in a particular activity, and ψₐ(α) refers to matching of the actors participating in execution of a particular activity, and ψᵥ(α, φ) means a weight value for particular participation link (α, φ). By using the above workflow network related functions, ωₐ(α) becomes π_{c}(εₚ(α)), and ψᵥ(α, φ) means the weight value of a connection link from α to φ.

In the present embodiment, it is possible that the weight value for every link is set to 1 only. In such a case, every connection link between α and φ can have the weight value of “1,” and the weight value can be set to “0” if there is no connection link between α and φ. When the weight values of the involvement link and participation link can be expressed with 0 and 1, it is referred to as a binary affiliation network. When the weight values of the links are expressed with 0 and values greater than 1, it is referred to as a multi-value affiliation network. The binary affiliation network will be described present embodiment for the convenience of description.

Shown below is an example of affiliation network knowledge discovery algorithm for converting a workflow network to an affiliation network by use of the above functions. It shall be appreciated that the scope of right of the present invention is not restricted to the below algorithm but is extended to all other algorithms that are modified from the same algorithm to perform equivalent roles.

```
    Input Γ_{C} = {function(δ, κ), set(A, T)} (workflow process model)
        Γ_{R} = {function(ε, π), set(A, R, P)} (workflow role and actor
allocation model)
    Output Λ = {function(σ, ψ, S) over set(A, P, V)} (workflow
affiliation network model)
    Begin Procedure
        /* involvement link and weight value by involvement function */
        For (∀φ ε actor set) Do
            Begin
                Add all members of (εₐ(πₚ(φ)) To σₚ(φ);
                Add “weight value=1” To σᵥ(all edges of (φ, σₚ(φ)));
            End
        /* participation link and weight value by participation function */
        For (∀α ∪ activity set) Do
            Begin
                Add all members of (π_{c}(εₚ(α)) To ψₐ(α);
                Add “weight value=1” To ψᵥ(all edges of (α, ψₐ(α)));
            End
    End Procedure
```

Here, “A” is a set of activities, and “P” is a set of actors, while “R” is a set of roles. Moreover, “V” is a set of weight values, and “T” is a set of transition conditions.

The affiliation network converted from the workflow procedure shown in FIG. 4 by use of the above algorithm is shown in FIG. 5.

In FIG. 5, the affiliation relation between actors φₐ, φ_{b},φ_{c}, φ_{d}, φₑ and activities α_{A}, α_{B}, α_{C}, α_{D}, α_{E}, α_{F} can be assessed. For example, actor φ_{c} is involved with activities α_{A}, α_{D}, α_{E}, and activity α_{D} is participated by actors φₐ, φ_{b},φ_{c}. Since the affiliation network shown in FIG. 5 is a binary affiliation network, the weight value of every link is “1.”

Afterwards, in S102, the affiliation matrix computation unit 130 generates an affiliation matrix based on the affiliation network in order to analyze the generate affiliation network.

The affiliation network generated by the affiliation matrix computation unit 130 is illustrated in FIG. 6, and the row and the column axis of the affiliation matrix are constituted with activities constituting the affiliation network and actors assigned for execution of these activities.

The generated affiliation matrix takes the form of

$${X}^{A \cdot P} = [ \begin{matrix}0 & A \\ {A}^{′} & 0\end{matrix} ] ,$$

as shown in FIG. 6.

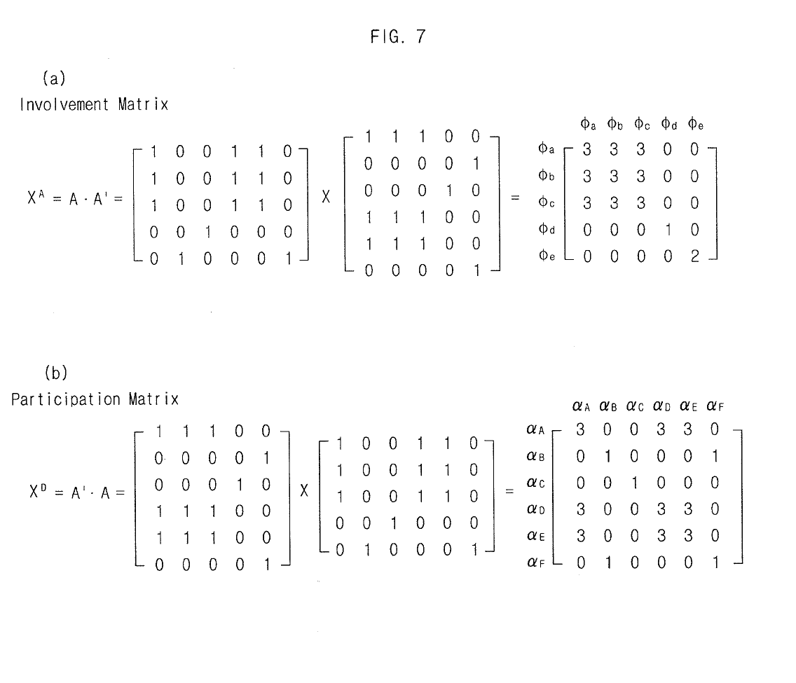

Then, the affiliation matrix computation unit 130 can generate an involvement matrix and a participation matrix from the generated affiliation matrix (S104). Specifically, involvement matrix X^{A} can be generated by multiplying A and A′, which are submatrices of the affiliation matrix, i.e., X^{A}=A A′, and participation matrix X^{P} can be generated by multiplying A′ and A, i.e., X^{P}=A′ A. Illustrated in FIG. 7 is how involvement matrix and participation matrix are generated from the affiliation matrix.

Then, the analysis unit 140 analyzes the affiliation network based on the generated affiliation matrix (S106, S108).

Specifically, the analysis unit 140 can determine whether an actor is involved in an activity by analyzing the generated involvement matrix (S106). For this, the analysis unit 140 can utilize various techniques for analyzing affiliation network, such as density analysis, centrality analysis, etc.

In FIG. 7, the generated involvement matrix (X^{A}) is a 5*5 matrix in which 5 actors assigned for execution of the pertinent workflow network are arranged in the row and the column. The elements include diagonal elements and non-diagonal elements. The non-diagonal elements refer to the numbers of activities in which two actors paired from the row and the column, respectively, are jointly involved, and the diagonal elements refer to the numbers of activities in which each of the actors is involved. For example, it can be seen that there are 3 activities in which the first actor φₐ and the third actor φ_{c} are jointly involved and that there are 2 activities in which the fifth actor φₑ is involved.

Moreover, the analysis unit 140 can analyze the generated participation matrix to determine the involvement of the actor in the activity (S108). The participation matrix (X^{P}) is a 6*6 matrix in which 6 activities constituting the pertinent workflow network are arranged in the row and the column. The elements include diagonal elements and non-diagonal elements. The non-diagonal elements refer to the numbers of actors jointly participating in execution of two activities paired from the row and the column, respectively, and the diagonal elements refer to the numbers of actors assigned for execution of each of the activities. For example, it can be seen that there are 3 actors jointly participating in activities α_{A} and α_{D} and that 3 actors have participated in execution of activities α_{A}, α_{D}, α_{E}, respectively, on the diagonal matrix. It can be also seen that 1 actor has participated in execution of each of the remaining activities of α_{B}, α_{C}, α_{F}.

Afterwards, the output unit 150 displays analysis results obtained through the analysis unit 140 to the user through the screen or other display means (S110).

Through the above-described configurations of the present invention, an administrator can select a desired workflow network model from a workflow management system, which is built within an organization, to show an affiliation relation among all human resources belonging to the organization and their associated processes and can assess the human resources assigned to tasks carried out by the organization and their associated costs and affiliation level by analyzing the affiliation relation.

Moreover, it is possible to allow the administrator of the organization to obtain a database for efficient construction of an affiliation network and proper distribution of funds, resources and personnel that has been difficult to be provided by the conventional workflow system analysis methods, pursuant to variable organizational member relations.

An embodiment of the present invention can be realized in the form of program instructions, which can be performed through various electronic data processing means, and can be written in a storage medium, which can include program instructions, data files, data structures and the combination thereof. The program instructions stored in the storage medium can be designed and configured specifically for the present invention or can be publically known and available to those who are skilled in the field of software. Examples of the storage medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above description has been provided in illustrative purposes only, and it shall be appreciated that it is possible for any ordinarily skilled person in the art to which the present invention pertains to easily modify the present invention without departing the technical ideas and essential features of the present invention. Therefore, it shall be appreciated that the embodiments described above are illustrative, not restrictive. For instance, any elements described to be combined can be also embodied by being separated, and likewise, any elements described to be separated can be also embodied by being combined.

The scope of the present invention shall be defined not by the above description but rather by the claims appended below, and it shall be understood that all possible permutations or modifications that can be contrived from the meanings, scopes and equivalents of the claims are included in the scope of the present invention.

What is claimed is:

1. A system for analyzing an affiliation network based on workflow, the system comprising:
a workflow management unit configured to generate and manage a workflow network constituted with a plurality of activities;
an affiliation network conversion unit configured to convert the workflow network to an affiliation network indicating a relation between an actor and the activity;
an affiliation matrix computation unit configured to generate an affiliation matrix based on the affiliation network; and
an analysis unit configured to analyze the affiliation network based on the affiliation matrix.

2. The system of claim 1, wherein the affiliation network conversion unit is configured to convert the workflow network to the affiliation network indicating a relation between the actor and the activity based on role information and actor information defined on the workflow network.

3. The system of claim 1, wherein the workflow network comprises at least one of activity information, repository information, role information and actor information.

4. The system of claim 1, wherein the affiliation matrix computation unit is configured to generate an involvement matrix and a participation matrix from the affiliation matrix.

5. The system of claim 4, wherein the analysis unit is configured to analyze the involvement matrix to determine whether the actor is involved in the activity and is configured to analyze the participation matrix to determine whether the actor is participated in the activity.

6. The system of claim 5, wherein a row and a column of the involvement matrix correspond to the actor,
wherein a non-diagonal element of the involvement matrix is configured to display the number of activities in which two actors paired from the row and the column, respectively, are jointly involved, and
wherein a diagonal element of the involvement matrix is configured to display the number of activities in which each actor is involved.

7. The system of claim 5, wherein a row and a column of the participation matrix correspond to the activity,
wherein a non-diagonal element of the participation matrix is configured to display the number of actors jointly participating in execution of two activities paired from the row and the column, respectively, and
wherein a diagonal element of the participation matrix is configured to display the number of actors assigned for execution of each activity.

8. The system of claim 1, further comprising a storage unit configured to store at least one of the workflow network, the affiliation network and the affiliation matrix.

9. The system of claim 8, wherein the storage unit comprises:
a workflow definition DB configured to store and manage the workflow network;
an affiliation network DB configured to store and manage the affiliation network; and
an affiliation matrix DB configured to store and manage the affiliation matrix.

10. A method for analyzing an affiliation network based on workflow by using a system for analyzing an affiliation network based on workflow, the method comprising:
converting a workflow network constituted with a plurality of activities to an affiliation network indicating a relation between an actor and the activity;
generating an affiliation matrix based on the affiliation network; and
analyzing the affiliation network based on the generated affiliation matrix.

11. The method of claim 10, wherein the workflow network is converted to the affiliation network indicating a relation between the actor and the activity based on role information and actor information defined on the workflow network.

12. The method of claim 10, wherein the workflow network comprises at least one of activity information, repository information, role information and actor information.

13. The method of claim 10, wherein the generating of an affiliation matrix further comprises generating an involvement matrix and a participation matrix from the affiliation matrix.

14. The method of claim 13, wherein the analyzing of the affiliation network comprises:
analyzing the involvement matrix to determine whether the actor is involved in the activity; and
analyzing the participation matrix to determine whether the actor is participated in the activity.

15. The method of claim 14, wherein a row and a column of the involvement matrix correspond to the actor,
wherein a non-diagonal element of the involvement matrix is configured to display the number of activities in which two actors paired from the row and the column, respectively, are jointly involved, and
wherein a diagonal element of the involvement matrix is configured to display the number of activities in which each actor is involved.

16. The method of claim 14, wherein a row and a column of the participation matrix correspond to the activity,
wherein a non-diagonal element of the participation matrix is configured to display the number of actors jointly participating in execution of two activities paired from the row and the column, respectively, and
wherein a diagonal element of the participation matrix is configured to display the number of actors assigned for execution of each activity.

17. The method of claim 10, further comprising displaying a result of analyzing the affiliation network.

18. A computer-readable storage medium storing a computer-executable program for execution of a method for analyzing an affiliation network based on workflow by using a system for analyzing an affiliation network based on workflow, the method comprising:
converting a workflow network constituted with a plurality of activities to an affiliation network indicating a relation between an actor and the activity;
generating an affiliation matrix based on the affiliation network; and
analyzing the affiliation network based on the generated affiliation matrix.
